(19) United States
(12) Patent Application Publication
(10) Pub. No.: US 2026/0111529 A1
(43) Pub. Date: Apr. 23, 2026

(54) SYSTEMS AND METHODS FOR OPTIMIZING COMPONENT AUTHENTICATION CHECKS BASED ON INTRUSION DETECTION HISTORY

(71) Applicant: Dell Products L.P., Round Rock, TX (US)

(72) Inventors: Adolfo S. MONTERO, Pflugerville, TX (US); Yu-Chi CHIN, Sunnyvale, CA (US); Jen-Chih LIU, New Taipei City (TW)

(73) Assignee: Dell Products L.P., Round Rock, TX (US)

(21) Appl. No.: 18/922,934

(22) Filed: Oct. 22, 2024

(51) Int. Cl. G06F 21/44; G06F 21/55

(52) U.S. Cl. CPC G06F 21/44; G06F 21/554

(57) ABSTRACT

An information handling system may include an information handling resource and a management controller communicatively coupled to the information handling resource and configured to determine if an intrusion has occurred to an enclosure of the information handling system since a previous boot session or power cycle of the information handling system and if the intrusion has occurred, perform an authentication routine to determine if the information handling resource is an authentic component of the information handling system.

### TECHNICAL FIELD

The present disclosure relates in general to information handling systems, and more specifically to systems and methods for optimizing component authentication checks, including battery authentication checks, based on intrusion detection history.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many modern information handling systems utilize one or more rechargeable batteries for powering electrical and electronic components of the information handling system. Such batteries may be used when an external power supply is not available to the information handling system, whether such external power supply is unavailable due to a power grid failure or because a user decouples the information handling system from the external power supply for mobile usage of the information handling system.

A manufacturer of an information handling system may desire that the information handling system is able authenticate that one or more components, including a battery, are from the manufacturer itself or another trusted supplier. For example, battery authentication may be desired given that substandard or unapproved batteries may increase a risk of fire or other damage to an information handling system. Thus, battery authentication may be used to detect whether a battery installed in an information handling system is counterfeit.

While battery authentication schemes are in use, such battery authentication algorithms may take significant time and consume significant system power. Accordingly, systems and methods optimizing battery authentication checks may be desired.

### SUMMARY

In accordance with the teachings of the present disclosure, the disadvantages and problems associated with authentication checks for batteries and other hardware may be reduced or eliminated.

In accordance with embodiments of the present disclosure, an information handling system may include an information handling resource and a management controller communicatively coupled to the information handling resource and configured to determine if an intrusion has occurred to an enclosure of the information handling system since a previous boot session or power cycle of the information handling system and if the intrusion has occurred, perform an authentication routine to determine if the information handling resource is an authentic component of the information handling system.

In accordance with these and other embodiments of the present disclosure, a method may include determining if an intrusion has occurred to an enclosure of an information handling system since a previous boot session or power cycle of the information handling system and if the intrusion has occurred, performing an authentication routine to determine if an information handling resource integral to the information handling system is an authentic component of the information handling system.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to determine if an intrusion has occurred to an enclosure of an information handling system since a previous boot session or power cycle of the information handling system and if the intrusion has occurred, perform an authentication routine to determine if an information handling resource integral to the information handling system is an authentic component of the information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawing, in which like reference numbers indicate like features, and wherein:

FIG. 1 illustrates a block diagram of an example information handling system, in accordance with certain embodiments of the present disclosure;

FIG. 2 illustrates a flow chart of an example method for an intrusion event handler, in accordance with embodiments of the present disclosure; and

FIG. 3 illustrates a flow chart of an example method for optimizing hardware authentication checks based on intrusion detection history, in accordance with embodiments of the present disclosure.

### DETAILED DESCRIPTION

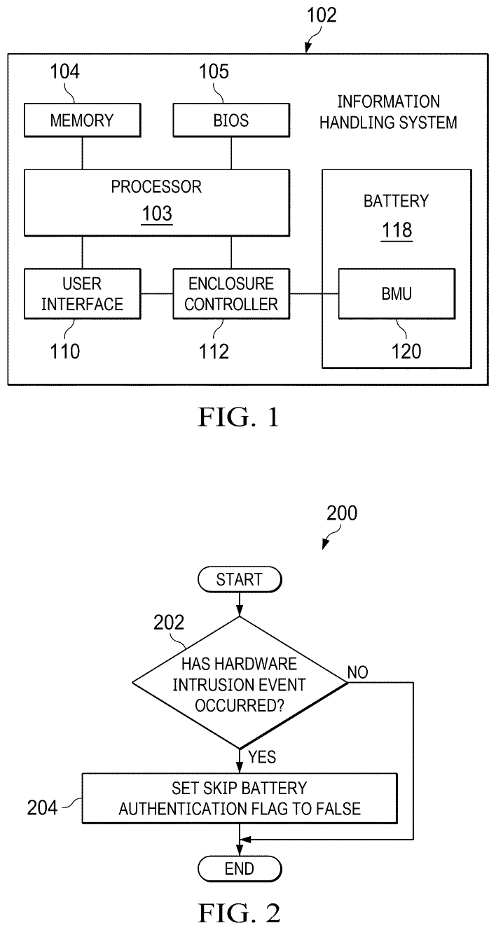

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSes), buses, memories, I/O devices and/or interfaces, storage resources, network interfaces, motherboards, and/or any other components and/or elements of an information handling system.

FIG. 1 illustrates a block diagram of an example information handling system 102, in accordance with certain embodiments of the present disclosure. In some embodiments, information handling system 102 may be a server. In other embodiments, information handling system 102 may be a personal computer (e.g., a desktop computer or a portable computer). In yet other embodiments, information handling system 102 may be a mobile device (e.g., a handheld gaming device, a smartphone, a tablet, etc.). As depicted in FIG. 1, information handling system 102 may include a processor 103, a memory 104 communicatively coupled to processor 103, a basic input/output system (BIOS) 105 communicatively coupled to processor 103, an enclosure controller 112 communicatively coupled to processor 103, a user interface 110 communicatively coupled to processor 103 and enclosure controller 112, and a battery 118 electrically coupled to selected components of information handling system 102.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 105, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, BIOS code may be configured to set components of information handling system 102 into a known state, so that one or more applications (e.g., an operating system or other application programs) stored on compatible media (e.g., memory 104) may be executed by processor 103 and given control of information handling system 102.

User interface 110 may comprise any instrumentality or aggregation of instrumentalities by which a user may interact with information handling system 102. For example, user interface 110 may permit a user to input data and/or instructions into information handling system 102 (e.g., via a keyboard, pointing device, push button, and/or other suitable component), and/or otherwise manipulate information handling system 102 and its associated components. User interface 110 may also permit information handling system 102 to communicate data to a user, e.g., by way of a display device or visual indicators such as light-emitting diodes.

Enclosure controller 112 may be configured to provide out-of-band management facilities for management of information handling system 102. Such management may be made by enclosure controller 112 even if information handling system 102 is powered off or powered to a standby state. Enclosure controller 112 may include a processor, memory, and an out-of-band network interface separate from and physically isolated from an in-band network interface. In certain embodiments, enclosure controller 112 may include or may be an integral part of a baseboard management controller (BMC), a remote access controller (e.g., a Dell Remote Access Controller or Integrated Dell Remote Access Controller), or an enclosure controller. In other embodiments, enclosure controller 112 may include or may be an integral part of a chassis management controller (CMC).

In accordance with embodiments of the present disclosure, enclosure controller 112 may, among other functions, perform battery management of battery 118, including performing battery authentication checks, as described in greater detail below.

Battery 118 may comprise a power source having one or more electrochemical cells with external connections for powering one or more electrical devices of information handling system 102, including processor 103, memory 104, BIOS 105, and enclosure controller 112. In particular, battery 118 may store chemical energy which may be converted to electrical energy to power one or more electrical devices. In some embodiments, battery 118 may comprise a rechargeable battery, for which electrical energy delivered to battery 118 may be converted to chemical energy, for storage and later conversion into electrical energy. In some embodiments, battery 118 may comprise a lithium-ion battery.

As shown in FIG. 1, battery 118 may include a battery management unit (BMU) 120. BMU 120 may comprise a microprocessor, digital signal processor, application-specific integrated circuit, field-programmable gate array, electrically erasable programmable read only memory, or any combination thereof, or any other device, system, or apparatus for controlling operation of battery 118. As such, BMU 120 may comprise firmware, logic, and/or data for controlling functionality of the battery subsystem. In operation, BMU 120 may control battery 118 based on commands received from enclosure controller 112.

In addition to processor 103, memory 104, BIOS 105, user interface 110, enclosure controller 112, and battery 118, information handling system 102 may include one or more other information handling resources.

In operation, enclosure controller 112 may condition execution of a battery authentication check on whether an intrusion detection into an enclosure of information handling system 102 has occurred. Thus, if an intrusion event has been detected since a previous session, which may be indicated by a flag set by an intrusion detection routine performed by enclosure controller 112 or another component of information handling system 102, enclosure controller 112 may perform a battery authentication routine to determine whether battery 118 is authentic. On the other hand, if an intrusion event has not been detected since a previous session, enclosure controller 112 may bypass the battery authentication routine, based on the assumption that it is unlikely battery 118 was replaced in the absence of an intrusion.

The performance of intrusion detection by enclosure controller 112 or another component of information handling system 102 may be performed in any suitable manner, including without limitation using the approach set forth in U.S. Patent Pub. No. 2024/0264207, which is incorporated by reference herein in its entirety.

FIG. 2 illustrates a flow chart of an example method 200 for an intrusion event handler, in accordance with embodiments of the present disclosure.

At step 202, enclosure controller 112 may determine whether a hardware intrusion event has occurred. For example, such indication of a hardware intrusion event may comprise a chassis intrusion of information handling system 102 since a previous boot session or power cycle. A chassis intrusion may indicate that a change in hardware inventory has occurred since the previous boot session, while absence of a chassis intrusion may indicate that the hardware inventory is unchanged. In some embodiments, a flag or other variable may indicate whether chassis intrusion has occurred (e.g., by means of a battery-powered circuit configured to assert or de-assert such flag or variable in a memory or other computer-readable medium in response to a sensor detecting a chassis intrusion). If a hardware intrusion event has occurred, method 200 may proceed to step 204. If a hardware intrusion event has not occurred, method 200 may end.

At step 204, in response to the hardware intrusion indicator flag being true, enclosure controller 112 may set a skip battery authentication flag to false. On a factory default boot of information handling system 102, the skip battery authentication flag may be set to true, in order to skip authentication in future boots until an intrusion occurs. After completion of step 204, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using information handling system 102 and/or any other system operable to implement method 200. In certain embodiments, method 200 may be implemented partially or fully in software and/or firmware embodied in computer-readable media.

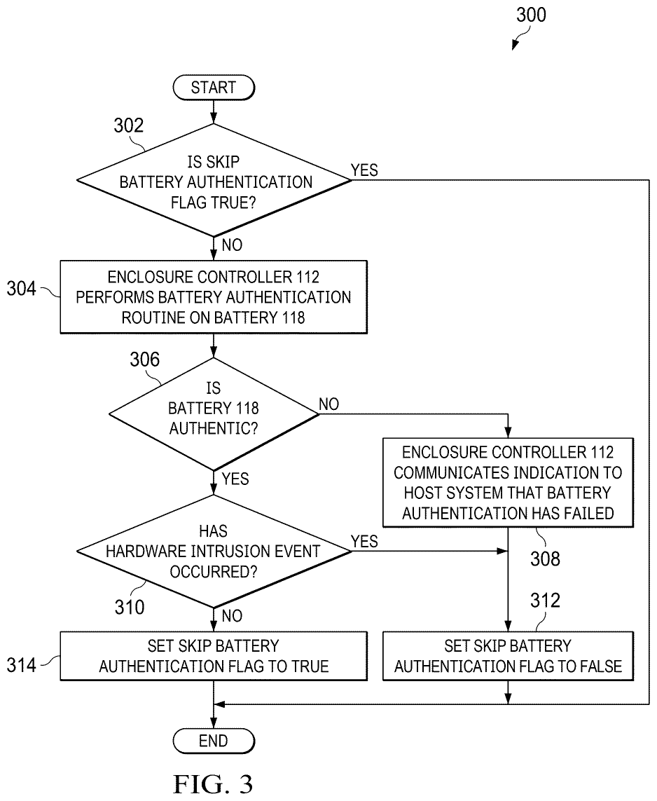

FIG. 3 illustrates a flow chart of an example method 300 for optimizing hardware authentication checks based on intrusion detection history, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, enclosure controller 112 may determine whether the skip battery authentication flag is true. If the skip battery authentication flag is true, method 300 may end. Otherwise, if the skip battery authentication flag is false, method 300 may proceed to step 304.

At step 304, enclosure controller 112 may perform a battery authentication routine on battery 118. A battery authentication routine may include any suitable algorithm to determine whether battery 118 was manufactured by the provider of information handling system 102 or a vendor or other supplier of battery 118 approved by the provider of information handling system 102. For example, in some embodiments, such authentication routine may include authenticating an encrypted signature associated with battery 118. In yet other embodiments, such authentication routine may include an asymmetric cryptographic algorithm, symmetric cryptographic algorithm for the previous generation products, or any post-quantum-computing algorithm.

At step 306, enclosure controller 112 may determine based on the battery authentication routine whether battery 118 is authentic, i.e., whether battery 118 is approved by a manufacturer, vendor, or other provider of information handling system 102. If battery 118 is not authentic, method 300 may proceed to step 308. Otherwise, method 300 may proceed to step 310.

At step 308, enclosure controller 112 may communicate an indication to a host system of information handling system 102 that battery authentication has failed. In response, the host system may perform a remedial action in the event that battery 118 is deemed inauthentic. Such remedial action may include, without limitation, communication of an alert to a user via user interface 110, disabling charging of battery 118, and/or any other suitable action. After completion of step 308, method 300 may proceed to step 312.

At step 310, enclosure controller 112 may determine whether a hardware intrusion event has occurred. If a hardware intrusion event has occurred, method 300 may proceed to step 312. Otherwise, method 300 may proceed to step 314.

At step 312, enclosure controller 112 may set the skip battery authentication flag to false. After step 312, method 300 may end.

At step 314, enclosure controller 112 may set the skip battery authentication flag to true. After step 314, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using information handling system 102 and/or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S. C. § 112(f) unless the words “means for” or “step for” are explicitly used in the particular claim.

What is claimed is:

1. An information handling system comprising:
an information handling resource; and
a management controller communicatively coupled to the information handling resource and configured to:
determine if an intrusion has occurred to an enclosure of the information handling system since a previous boot session or power cycle of the information handling system; and
if the intrusion has occurred, perform an authentication routine to determine if the information handling resource is an authentic component of the information handling system.

2. The information handling system of claim 1, wherein the information handling resource is a battery.

3. The information handling system of claim 1, wherein the management controller is further configured to perform a remedial action in response to determining that the information handling resource is inauthentic.

4. A method comprising:
determining if an intrusion has occurred to an enclosure of an information handling system since a previous boot session or power cycle of the information handling system; and
if the intrusion has occurred, performing an authentication routine to determine if an information handling resource integral to the information handling system is an authentic component of the information handling system.

5. The method of claim 4, wherein the information handling resource is a battery.

6. The method of claim 4, further comprising performing a remedial action in response to determining that the information handling resource is inauthentic.

7. An article of manufacture comprising:
a non-transitory computer-readable medium; and
computer-executable instructions carried on the computer-readable medium, the instructions readable by a processor, the instructions, when read and executed, for causing the processor to:
determine if an intrusion has occurred to an enclosure of an information handling system since a previous boot session or power cycle of the information handling system; and
if the intrusion has occurred, perform an authentication routine to determine if an information handling resource integral to the information handling system is an authentic component of the information handling system.

8. The article of manufacture of claim 7, wherein the information handling resource is a battery.

9. The article of manufacture of claim 7, the instructions for further causing the processor to perform a remedial action in response to determining that the information handling resource is inauthentic.
